(19) United States
(12) Patent Application Publication
(10) Pub. No.: US 2010/0184968 A1
(43) Pub. Date: Jul. 22, 2010

(54) METHOD FOR PREPARING AN OXIDISED CELLULOSE COMPRESS

(75) Inventors: Cecile Bertholon, Ternay (FR); Celine David, Villard-Bonnot (FR); Benjamin Herbage, La Mulatiere (FR)

Correspondence Address: HESLIN ROTHENBERG FARLEY & MESITI PC, 5 COLUMBIA CIRCLE, ALBANY, NY, 12203, US

(73) Assignee: SYMATESE, Chaponost (FR)

(21) Appl. No.: 12/668,055

(22) PCT Filed: Jul. 25, 2008
(86) PCT No.: PCT/FR08/51413

§ 371 Date: Jan. 7, 2010

(30) Foreign Application Priority Data
Jul. 26, 2007 (FR) 0705477

(51) Int. Cl. C08B 1/00

(52) U.S. Cl. 536/56

(57) ABSTRACT

A method for preparing an oxidized cellulose complex essentially comprises oxidizing the compress with a hypohalite, in the presence of an oxoammonium salt

### FIELD OF THE INVENTION

The invention relates to a novel method for oxidizing cellulose compresses.

After oxidation, the compresses thus obtained have a haemostatic and resorbable character, suitable for an application as implantable compresses.

More precisely, the method proposed in the context of the invention is implemented directly on the cellulose compresses. It is based on the oxidation of the primary alcohol function of the glucose residues of cellulose by an oxoammonium salt in the presence of a secondary oxidizing system. This method, carried out in aqueous solution, is easily implemented on the industrial scale.

### PRIOR ART

Surgical haemostatic compresses or compresses must be haemostatic, resorbable and easily handled by surgeons. These properties can be obtained with textiles based on oxidized cellulose.

As a reminder, cellulose (C₆H₁₀O₅)ₙ is a homopolymer belonging to the class of polysaccharides. It is formed of a linear chain of glucose molecules by β-1,4 glycosidic bonds.

It is known from the prior art that the haemostatic and resorbable properties of oxidized cellulose are obtained by the selective oxidation of the alcohol group carried by the carbon 6 of the anhydro-glucose unit, to carboxylic acid. The essential difficulty therefore stems from the selective oxidation of a primary alcohol, in the presence of secondary alcohol functions.

The compresses are generally supplied with carboxylic acid functions protonated or complexed with calcium ion (Ca²⁺), as described for example in documents GB 1 593 513 and U.S. Pat. No. 5,484,913.

At present, such compresses are obtained by subjecting the cellulose textile to the action of NO₂ in the presence of solvents. More precisely, the compresses are immersed in a solvent bath with bubbling of gaseous NO₂, as described for example in document EP 0 492 990.

However, these methods are not satisfactory because they require raw materials which are costly, hazardous and difficult to recycle, as well as a demanding installation.

A need therefore exists to develop novel methods, applicable industrially and less restrictive, for obtaining oxidized cellulose compresses, which are satisfactory in terms of degree of oxidation and mechanical strength.

The Applicant has surprisingly shown that another primary alcohol selective oxidation technique could be used successfully, directly on cellulose based compresses.

### SUMMARY OF THE INVENTION

Thus, the invention relates to a novel method for preparing oxidized cellulose compresses.

Such a method essentially comprises oxidizing the cellulose based compress with a hypohalite, in the presence of an oxoammonium salt.

This method is therefore implemented directly on a cellulose based compress as the starting material, that is a textile already prepared.

In the context of the present invention, “cellulose based” means the fact that the compress contains fibres which chemically resemble cellulose by their nature (glucose homopolymers with β-1,4 glycosidic bonds). However, in addition to cellulose, the material may for example be viscose which corresponds to a yarn obtained from regenerated cellulose.

In a prior step of the inventive method, the fibres or yarns are joined in textile form, which may equally well be woven or knitted or nonwoven.

In a preferred embodiment, the viscose yarn is placed in textile form by knitting. Various meshes can be considered, in particular jersey (conventionally knitted with a 220 dtex yarn with 42 filaments) or the hook (advantageously knitted with 110 dtex yarn with 40 filaments). In the context of the invention, the hook mesh is preferred.

Typically and for the compress application, the textile has a basis weight of about 50 to 100 g/m².

Also upstream of the inventive method, the textile thus obtained is advantageously subjected to a de-oiling step for removing the fats used in the spinning process. These fats essentially consist of spinning oil and acrylate adhesive coating the filaments.

Various de-oiling procedures are known from the prior art and can be implemented on the textile, in particular:

washing with lye and hot water (60° C.);

washing with cyclohexane or other fat solvents;

washing with ionic or other detergents, for example those from Thorquest.

The first step of the inventive method is therefore the selective oxidation of the primary alcohol groups located in position 6 of the anhydro-glucose units present in the compress.

This oxidation is carried out by incubating the cellulose based compress in a medium comprising a hypohalite and an oxoammonium salt.

This oxidation reaction has the primary advantage of taking place in aqueous medium and therefore without solvent, contrary to the prior art methods.

Oxoammonium salts are water-soluble oxidants capable of selectively oxidizing primary alcohols, when the reaction takes place in suitable pH and temperature conditions. The preferred oxoammonium salts according to the invention are di-tert-alkylated salts, in particular salts of 2,2,6,6-tetramethylpiperidine-1-oxide commonly called Tempo.

In such a reaction, they play the role of catalyst and are advantageously present in the reaction medium in the amount of 0.05 mole per mole of anhydro-glucose units in the cellulose sample treated (equivalent).

These oxoammonium salts must therefore be regenerated in situ by a secondary or auxiliary oxidizing system, in this case in the presence of a hypohalite, preferably sodium hypochlorite (NaOCl), such as Javel water containing 15% of active chlorine which is a common and inexpensive reactant.

In fact, this is an oxidizing system because, in addition to the hypohalite, it comprises a salt (advantageously a bromide) for transferring oxygen between the oxoammonium ion and the hypohalite. This “intermediary” is advantageously present in the reaction medium in the amount of at least 0.5 mole per mole of anhydro-glucose units in the cellulose sample treated (equivalent).

A preferred oxidizing system according to the invention is the NaOCl/NaBr (sodium bromide) system. Since the hypobromite ion is more reactive than the hypochlorite ion, the oxoammonium ions are rapidly regenerated according to the following diagram:

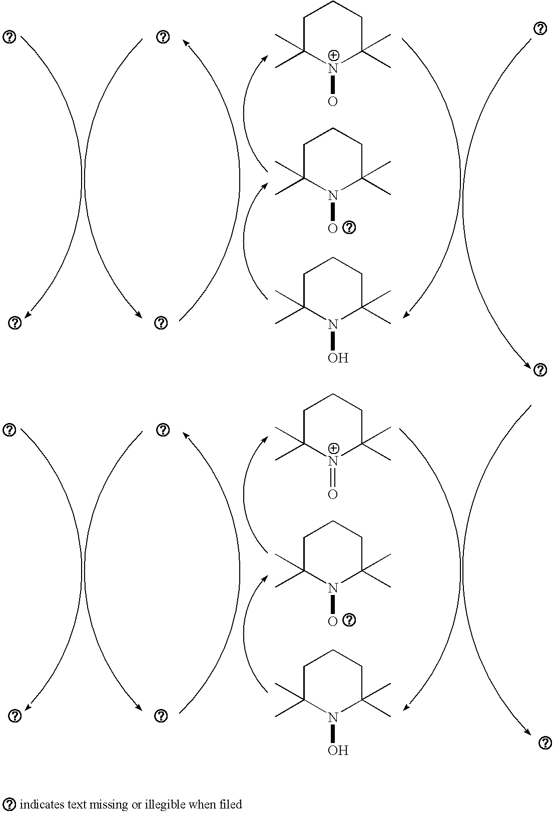

It is admitted that the use of these reactants for oxidizing primary alcohols had already been described, including in the context of carbohydrates.

However, the prior art never indicated that this oxidation reaction could be carried out successfully directly on a cellulose based textile and would give rise to a compress having an oxidation rate of 10% or higher (value corresponding to bioresorbable compresses), or even 12% (value corresponding to bioresorbable and haemostatic compresses) and even above 14%, compatible with the intended application, since the oxidation is also selective for the alcohol groups carried by the carbon 6 of the anhydro-glucose units of the cellulose present.

Furthermore, the Applicant has determined the conditions for treating such a compress, so that it does not lose its mechanical properties, which are also crucial for the intended application.

Advantageously, the reaction medium for the oxidation is formulated in deionized water, to avoid disturbing the ionic strength and the pH.

As described in the prior art, the oxidation reaction advantageously takes place at low temperature, for example at 4° C. These temperature conditions have been described as increasing the selectivity of the reactivity of the primary alcohol group, with regard to secondary alcohols. They also serve to limit the loss of mechanical integrity of the textile.

Similarly, the reaction advantageously takes place at basic pH, advantageously between 7 and 12.

It has been shown by the Applicant that a too sudden addition of hypohalite could affect the strength of the compress. This is why in a preferred embodiment, the hypohalite is added gradually to the reaction medium, as it is consumed.

At the start of the reaction and preferably, the hypohalite is added to the reaction medium so that the initial pH is between about 10 and 12.

The consumption of the hypohalite is reflected by a lowering of the pH. This is monitored and when it reaches the lowest values permitted for selectivity of the reaction, that is a pH between 7 and 9, advantageously equal to 8, hypohalite is added to the reaction medium in order to raise the pH.

The hypohalite addition is stopped when a number of moles of hypohalite per mole of anhydro-glucose units in the cellulose sample treated (equivalent) of between 5 and 7, advantageously of about 7, has been consumed.

In practice, the hypohalite can be added in 8 steps over a period of 3 to 4 hours.

When the hypohalite addition is complete, the oxidation reaction continues to a pH plateau of between 5 and 8. This pH plateau is generally reached after 24 hours of reaction.

A radical means for stopping the oxidation reaction is to add a primary alcohol to the reaction medium, such as methanol or ethanol, which reacts preferentially with the oxoammonium salt.

In practice and in the presence of Tempo, the end of the reaction is reflected by a reaction medium which turns from the initial yellow to white.

As already stated, an oxidized cellulose compress ready for use must have carboxylic acid functions which are either protonated, or complexed with calcium ions (Ca²⁺), to develop the desired haemostatic properties.

Thus, several alternatives are available for the rest of the method:

In the case in which an oxidized cellulose is desired having protonated carboxylic acid functions, the inventive method involves an additional protonation step.

Conventionally, this step is carried out by incubating the compress in a protonation medium.

This is advantageously carried out by incubating the compress in hydrochloric acid (HCl), advantageously in one or more baths of 1 mol/l (N) HCl, for several hours. Thus, at least two baths having a total duration of at least 2 hours 30 minutes complete the protonation of all the oxidized functions.

In practice and to avoid handling the treated compress, the oxidation medium can be removed by drainage.

In the case in which an oxidized cellulose desired having carboxylic acid functions complexed with calcium ions (Ca²⁺), several alternatives are available:
either the oxidation is carried out with reactants in the form of calcium salts, in particular calcium hypochlorite (CaCl₂O₂) and calcium bromide, in which case on completion of the reaction, the carboxylic acid functions are in COOCa form;
or alternatively, it may be feasible to carry out the incubation in the presence of the calcium source (in particular calcium acetate or CaCl₂), after oxidation;
a third alternative is to incubate the compress in a medium containing a calcium source, after the protonation step. Here also, particularly suitable calcium sources are calcium acetate or CaCl₂. In this new step, the Ca²⁺ ions replace the protons.

On completion of these oxidation steps, optionally of protonation, and optionally of complexation of the carboxylic acid functions with calcium ions, the compresses are washed and dried.

The compress is washed advantageously in a medium containing a solvent and/or water.

An alcohol and/or deionized water constitute a preferred washing medium. An alcohol of the isopropanol type allows faster subsequent drying in air.

These washings can be repeated and generally last a few hours, advantageously between 1 and 10 hours.

In a final step of the inventive method, the oxidized cellulose compresses ready for use are dried by any suitable means, in particular with air or under a hood.

They may also undergo treatments associated with the intended application: conditioning in individual packages, sterilization, etc.

Conditioning can be carried out in a modified atmosphere, for example with a very low residual moisture content, or an inert gas to improve the stability of the compress over time.

The compresses treated by the inventive method are advantageously produced with viscose yarns knitted in a hook mesh.

It has been demonstrated that cellulose based compresses subjected to the method as described in the present invention had a uniform oxidation of 10% or higher, or even 12%, and even 14% or higher, while preserving the structure and mechanical strength of the textile.

Furthermore and characteristically in comparison with the prior art, the inventive method confers great selectivity with regard to oxidation of the primary alcohol group carried by the carbon 6 of the anhydro-glucose units of the treated cellulose to carboxylic acid. Thus, the compresses obtained by the inventive method have a primary alcohol oxidation selectivity of 70% or higher, advantageously 75%, or even 80%, or 85%, or 90% or higher or equal to 95%. This quantity is quantifiable by NMR in particular.

### EXEMPLARY EMBODIMENTS

The present invention will now be illustrated in greater detail via the exemplary embodiments presented below, in conjunction with the appended figures. However, these exemplary embodiments are not at all limiting.

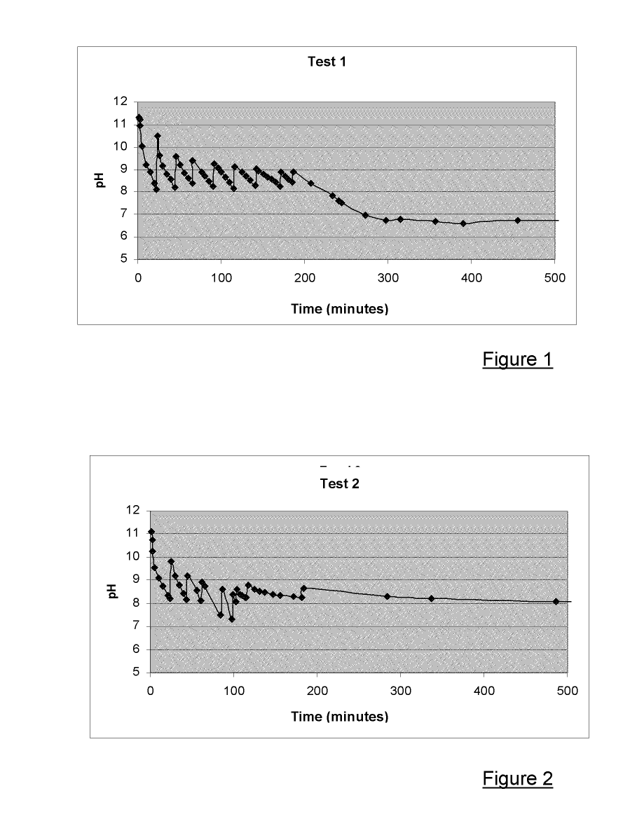

FIG. 1 shows the change in pH of the reaction medium during the oxidation reaction for test 1.

FIG. 2 shows the change in pH of the reaction medium during the oxidation reaction for test 2

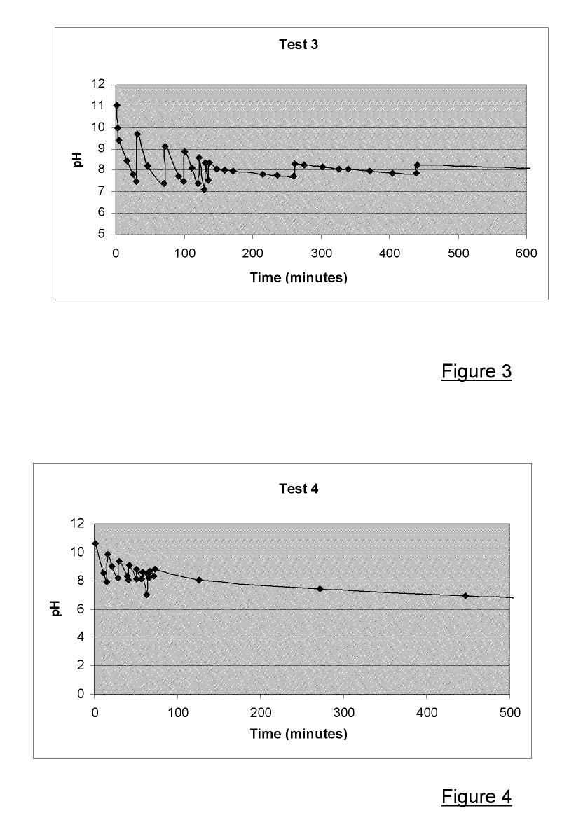

FIG. 3 shows the change in pH of the reaction medium during the oxidation reaction for test 3.

FIG. 4 shows the change in pH of the reaction medium during the oxidation reaction for test 4.

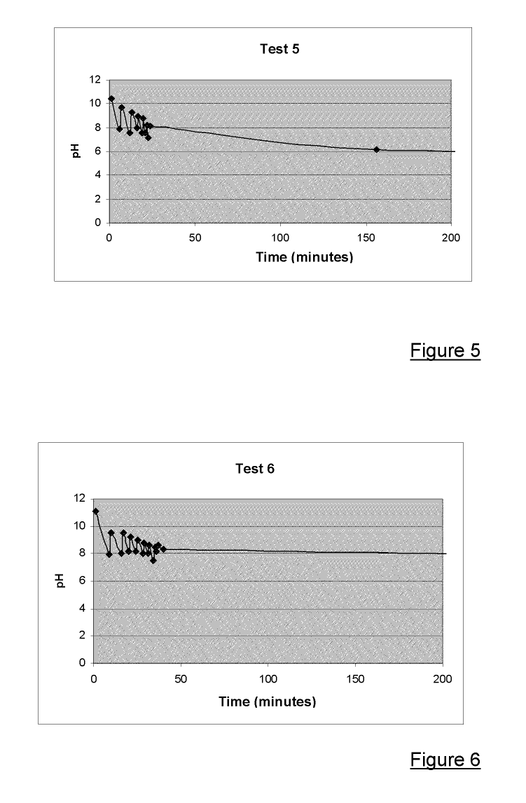

FIG. 5 shows the change in pH of the reaction medium during the oxidation reaction for test 5.

FIG. 6 shows the change in pH of the reaction medium during the oxidation reaction for test 6.

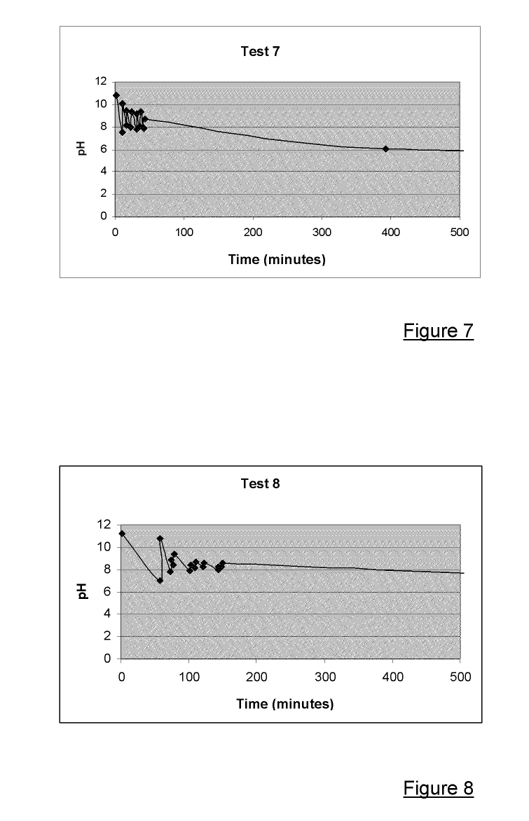

FIG. 7 shows the change in pH of the reaction medium during the oxidation reaction for test 7.

FIG. 8 shows the change in pH of the reaction medium during the oxidation reaction for test 8.

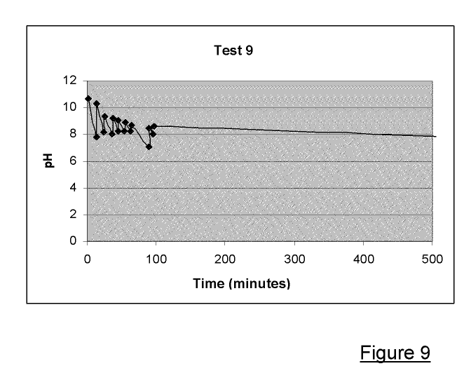

FIG. 9 shows the change in pH of the reaction medium during the oxidation reaction for test 9.

### 1. CELLULOSE BASED COMPRESSES

The experiments were carried out on compresses produced with viscose yarns knitted with two types of mesh:
jersey mesh, knitted with 220 dtex yarn with 42 filaments (test 3);

hook mesh, knitted with 110 dtex yarn with 40 filaments (tests 1 and 2).

These knits have a basis weight of about 67.5 g/m².

For these products, the oiling step takes place when the yarn is produced, just before winding. Accordingly, all these knits are therefore oiled.

### 2. OXIDATION REACTION

For tests 1 to 4, the cellulose compress is placed in a reaction medium comprising:

sodium bromide (NaBr);

sodium hypochlorite containing 15% active chlorine (NaOCl) or Javel water;

Tempo or 2,2,6,6-tetramethylpiperidine-1-oxide;

deionized water at 4° C.

For these tests, the following reactants were added to the reaction medium in the quantities indicated in the table below:

| | No. of moles per mole of | mg/ml of |
|---|---|---|
| | anhydro-glucose units in the cellulose | reaction |
| Reactant | sample treated (equivalents) | medium |
| Tempo | 0.05 | 1.2 |
| NaBr | 0.787 | 12.5 |
| NaOCl total (added | 6.97 | 96.75 |
| throughout the | | |
| reaction) | | |

The reaction medium consists of 40 ml of deionized water per 1 g of cellulose.

At the start of the reaction, the Tempo and NaBr are added in full to the reaction medium. On the other hand, only part of the NaOCl (0.486 mole per mole of anhydro-glucose units is used in the cellulose sample treated (equivalents) is added, in order to obtain an initial pH between 11 and 12.

The reaction takes place at 4° C. The change in the pH of the reaction medium is monitored, and NaOCl is added to the reaction medium in the conditions given in the table below:

| | Test 1 | Test 2 | Test 3 | Test 4 |
|---|---|---|---|---|
| Cellulose | Hook | Hook | Jersey | Jersey |
| Temperature | 4° C. | 4° C. | 4° C. | Ambient |
| pH of NaOCl addition | 8.2 | 8.2 | 7.5 | 8.2 |
| Number of additions | 8 | 8 | 8 | 8 |
| Number of moles per | 0.81 | 0.81 | 0.81 | 0.81 |
| mole of anhydro-glucose | | | | |
| units in the cellulose | | | | |
| sample treated | | | | |
| (equivalents) per addition | | | | |
| Oxidation time | 1392 min | 1412 min | 1404 min | 1383 min |
| pH plateau | 6.36 | 7.51 | 7.3 | 5.11 |

The variations in pH during the reaction are shown in FIGS. 1 to 4. The pH “increases” correspond to the addition of NaOCl. The total quantity of NaOCl was consumed during 8 additions extending over a period of 3 to 4 hours. The reaction then continues to a total reaction time of about 24 hours. At the end of the reaction, the reaction medium reaches a pH plateau of between 5 and 8.

### 3. PROTONATION REACTION

The oxidation reaction is considered as terminated when the reaction medium turns from yellow to white. It was stopped by adding methanol.

The oxidizing reaction medium was drained and replaced by a protonation medium in the following conditions:

| HCl 1 mol/l | | | | |
|---|---|---|---|---|
| (N) | Test 1 | Test 2 | Test 3 | Test 4 |
| No. of baths | 2 | 2 | 2 | 2 |
| Total time | 7 h | 3 h | 3 h | 4 h 50 |

### 4. WASHING OF COMPRESSES

The compresses were washed in the following conditions:

| | Test 1 | Test 2 | Test 3 | Test 4 |
|---|---|---|---|---|
| 1^{st} | Untreated | Deionized water/ | Deionized water/ | Deionized/ |
| washing | water | isopropanol | isopropanol | water |
| | for 5 | bath (50/50) | bath (50/50) | isopropanol |
| | minutes | Time: 1 h 30 | Time: 1 h 30 | bath (50/50) |
| | | | | Time: 1 h 40 |
| 2^{nd} | — | Isopropanol bath | Isopropanol bath | Isopropanol |
| washing | | Time: 1 h | Time: 1 h | bath |
| | | | | Time: 1 h |

The compresses were then dried in the open air under a hood.

### 5. RESULTS

The oxidized cellulose compresses were tested for various desired properties:

| | Test 1 | Test 2 | Test 3 | Test 4 | Reference |
|---|---|---|---|---|---|
| Oxidation rate | 8.50% | 17.70% | 17.30% | 14.70% | Between |
| | | | | | 14 and |
| | | | | | 25% |
| Total | +/− | + | + | + | + |
| solubilisation | | | | | |
| in caustic | | | | | |
| soda | | | | | |
| Mechanical | R− | R++ | R++ | R+ | R+ |
| strength | | | | | |
| Appearance of | Presence | Sound | Slight | Slight | Sound |
| textile | of holes | | laddering, | laddering | |
| | | | no holes | | |

The reference corresponds to a cellulose compress oxidized by the prior art methods, that is oxidation with NO₂ and in the presence of solvent according to document EP 0 492 990.

It is found that washing with untreated water does not yield satisfactory results: the corresponding compress (test 1) has holes and an insufficient oxidation rate.

The compresses of tests 2 and 3 yield perfectly satisfactory results, both in terms of oxidation degree and mechanical strength, thus validating the feasibility and advantage of the present invention. The “hook” meshes appear to behave better than the looser “jersey” meshes, but basically, the choice of the textile has no effect on the oxidation rate.

Furthermore and as expected, the comparison of tests 3 and 4 confirms that the low temperature conditions (4° C. versus ambient temperature) yield better results, both in terms of oxidation rate and mechanical strength. However, the prostheses obtained in the conditions of test 4 remain acceptable.

Further tests were performed to check that minor changes in the experimental conditions, within the desired field of protection remained acceptable. Thus tests were conducted on the effect of variations affecting:
the quantity of water in the reaction medium (tests 5 and 6 to be compared with test 3);
the quantity of Javel water (tests 5 and 7 to be compared with test 3);
the quantity of Tempo catalyst (test 7 to be compared with test 3);
the use of NaCl instead of NaBr (test 8 to be compared with test 6);
the use of a nonwoven 110 dtex, 40 filaments yarn instead of the hook mesh knit (test 9 to be compared with test 2);
complexation with calcium ions (test 10 to be compared with test 2).

The results obtained are given in the tables below, and also in FIGS. 5 to 9. It is found that in all these modified conditions, the compresses obtained have less favourable properties, particularly in terms of oxidation rate and mechanical strength, than in the conditions determined as the most favourable, but which nevertheless remain acceptable for the intended application.

### Test 5

| | No. of moles per mole of | |
|---|---|---|
| | anhydro-glucose units in the | |
| | cellulose sample treated | mg/ml of reaction |
| Reactant | (equivalents) | medium |
| Tempo | 0.05 | 4.8 |
| NaBr | 0.787 | 50 |
| Total NaOCl (added | 5.35 | 297 |
| throughout the | | |
| reaction) | | |

The reaction medium consists of 10 ml of deionized water per 1 g of cellulose.

### Test 6

| | No. of moles per mole of | |
|---|---|---|
| | anhydro-glucose units in the | |
| | cellulose sample treated | mg/ml of reaction |
| Reactant | (equivalents) | medium |
| Tempo | 0.05 | 3.2 |
| NaBr | 0.787 | 33.3 |
| Total NaOCl (added | 6.97 | 258 |
| throughout the | | |
| reaction) | | |

The reaction medium consists of 15 ml of deionized water.

### Test 7

| | No. of moles per mole of | |
|---|---|---|
| | anhydro-glucose units in the | |
| | cellulose sample treated | mg/ml of reaction |
| Reactant | (equivalents) | medium |
| Tempo | 0.06 | 3.85 |
| NaBr | 0.787 | 33.3 |
| Total NaOCl (added | 5.35 | 198 |
| throughout the | | |
| reaction) | | |

The reaction medium consists of 15 ml of deionized water.

| | Test 5 | Test 6 | Test 7 |
|---|---|---|---|
| Cellulose | Jersey | Jersey | Jersey |
| Temperature | 4° C. | 4° C. | 4° C. |
| pH of NaOCl addition | 8.2 | 8.2 | 8.2 |
| Number of additions | 6 | 8 | 6 |
| Number of moles per mole of | 0.81 | 0.81 | 0.81 |
| anhydro-glucose units in the | | | |
| cellulose sample treated | | | |
| (equivalents) per addition | | | |
| Oxidation time | 1402 min | 1417 min | 1422 min |
| pH plateau | 5.27 | 5.59 | 5.84 |

The oxidation was stopped with methanol in the case of test 5 and with ethanol for tests 6 and 7.

### Protonation:

| 1 mol/l (N) HCl | Test 5 | Test 6 | Test 7 |
|---|---|---|---|
| No. of baths | 2 | 2 | 3 |
| Total time | 2 h 40 | 3 h 55 | 3 h 25 |

### Washings:

| | Test 5 | Test 6 | Test 7 |
|---|---|---|---|
| 1^{st} | Deionized water/ | Deionized water/ | Deionized water/ |
| washing | isopropanol bath | isopropanol bath (50/50) | isopropanol bath |
| | (50/50) | Time: 1 h | (50/50) |
| | Time: 1 h 20 | | Time: 1 h 30 |
| 2^{nd} | Isopropanol bath | Isopropanol bath | Isopropanol bath |
| washing | Time: 1 h 40 | Time: 1 h 30 | Time: 1 h 40 |

The drying was carried out under a hood.

### Results:

| | Test 5 | Test 6 | Test 7 |
|---|---|---|---|
| Oxidation rate | 13.60% | 15.20% | 14.30% |
| Total solubilisation in caustic soda | + | + | + |
| Mechanical strength | R ++ | R ++ | R ++ |
| Appearance of textile | Slight | Slight | Slight |
| | laddering | laddering | laddering |

### Test 8

| | No. of moles per mole of | |
|---|---|---|
| | anhydro-glucose units in the | mg/ml of |
| | cellulose sample treated | reaction |
| Reactant | (equivalents) | medium |
| Tempo | 0.05 | 3.2 |
| NaBr | 1.39 | 33.3 |
| Total NaOCl (added | 6.97 | 258 |
| throughout the reaction) | | |

The reaction medium consists of 15 ml of deionized water per 1 g of cellulose.

| | Test 8 |
|---|---|
| Cellulose | Jersey |
| Temperature | 4° C. |
| pH of NaOCl addition | 8.2 |
| Number of additions | 8 |
| Number of moles per mole of anhydro-glucose units in the | 0.81 |
| cellulose sample treated (equivalents) per addition | |
| Oxidation time | 1412 min |
| pH plateau | 5.27 |

The oxidation was stopped with ethanol.

### Protonation:

| 1 mol/l (N) HCl | Test 8 |
|---|---|
| No. of baths | 2 |
| Total time | 2 h 50 |

### Washings:

| | Test 8 |
|---|---|
| 1^{st} washing | Deionized water/isopropanol bath (50/50) |
| | Time: 1 h 10 |
| 2^{nd} washing | Isopropanol bath |
| | Time: 1 h 45 |

The drying was carried out under a hood.

### Results:

| | Test 8 |
|---|---|
| Oxidation rate | 13.80% |
| Total solubilisation in caustic soda | + |
| Mechanical strength | R+/− |
| Appearance of textile | Slight laddering |

### Test 9

| | No. of moles per mole of | |
|---|---|---|
| | anhydro-glucose units in the | mg/ml of |
| | cellulose sample treated | reaction |
| Reactant | (equivalents) | medium |
| Tempo | 0.05 | 1.2 |
| NaBr | 0.787 | 12.5 |
| Total NaOCl (added | 6.97 | 96.75 |
| throughout the reaction) | | |

The reaction medium consists of 40 ml of deionized water per 1 g of cellulose.

| | Test 9 |
|---|---|
| Cellulose | 110 dtex yarn, |
| | 40 filaments |
| Temperature | 4° C. |
| pH of NaOCl addition | 8.2 |
| Number of additions | 8 |
| Number of moles per mole of anhydro-glucose units | 0.81 |
| in the cellulose sample treated (equivalents) per | |
| addition | |
| Oxidation time | 1406 min |
| pH plateau | 6.13 |

The oxidation was stopped with ethanol.

### Protonation:

| 1 mol/l (N) HCl | Test 9 |
|---|---|
| No. of baths | 2 |
| Total time | 3 h 25 |

### Washings:

| | Test 9 |
|---|---|
| 1^{st} washing | Deionized water/isopropanol bath (50/50) |
| | Time: 1 h 55 |
| 2^{nd} washing | Isopropanol bath |
| | Time: 1 h 25 |

The drying is carried out under a hood.

### Results:

| | Test 9 |
|---|---|
| Oxidation rate | 13.60% |
| Total solubilisation in caustic soda | + |

Test 10: Compress complexed with calcium ions

The compress was treated in the same conditions as those of test 2. This compress is immersed in a bath comprising 3.33 moles of calcium acetate per mole of anhydro-glucose units in the cellulose sample treated (equivalents) in a deionized water/isopropanol (50/50), mixture, for 2 hours.

Two washings of 30 min, each in isopropanol baths, are then carried out.

### Results:

| | Test 10 |
|---|---|
| Oxidation rate | 0.40% |
| Total solubilisation in caustic soda | − |
| Mechanical strength | R+ |
| Appearance of textile | Sound |

The drop in the oxidation rate (0.4% compared to 17.7%) shows that the protons have been replaced by calcium ions.

More precisely, calcium determinations were carried out to validate the replacement of the acid functions by calcium. Thus, the calcium content on this sample was estimated at 6.6%, corresponding to a rate of substitution of the acid functions by the calcium of over 90%.

The compress thus obtained also has all the desired properties.

1. Method for preparing an oxidized cellulose compress comprising oxidation of a cellulose based compress with a hypohalite, in the presence of an oxoammonium salt.

2. Method for preparing a compress according to claim 1, wherein the oxidation is carried out in a reaction medium of which the initial pH is between 10 and 12.

3. Method for preparing a compress according to claim 2, wherein the reaction medium is enriched with hypohalite when pH of the reaction medium reaches a value of between 7 and 9.

4. Method for preparing a compress according to claim 3, wherein addition of hypohalite to the medium is stopped when a total quantity of hypohalite between 5 and 7 moles per mole of anhydro-glucose units in the cellulose (equivalents) has been added to the medium.

5. Method for preparing a compress according to claim 2, wherein the oxoammonium salt comprises 2,2,6,6-tetramethylpiperidine-1-oxide (Tempo).

6. Method for preparing a compress according claim 1, wherein the hypohalite comprises sodium hypochlorite.

7. Method for preparing a compress according to claim 1, wherein the oxidation is carried out in the presence of a hypohalite regenerating salt.

8. Method for preparing a compress according to claim 1, wherein the oxidation is carried out in the presence of a source of calcium ions.

9. Method for preparing a compress according to claim 2, wherein the oxidation is stopped when the reaction medium reaches a pH plateau between 5 and 8.

10. Method for preparing a compress according to claim 1, wherein the oxidation is stopped by addition of an excess of primary alcohol.

11. Method for preparing a compress according to claim 1, wherein the oxidation is carried out at a temperature of 4° C.

12. Method for preparing a compress according to claim 2, wherein, after the oxidation is stopped, the reaction medium is removed by drainage.

13. Method for preparing a compress according to claim 1, wherein, after oxidation, the compress is incubated in a protonation medium.

14. Method for preparing a compress according to claim 1, wherein, after oxidation or after protonation, the compress is incubated in a medium rich in calcium ions.

15. Method for preparing a compress according to claim 1, wherein, after oxidation, the cellulose based compress is subjected to a de-oiling step.

16. Method for preparing a compress according to claim 1, wherein, the cellulose based compress is subsequently washed and dried.

17. Haemostatic and resorbable compress obtained by the method according to claim 1, at an oxidation rate of 10% or higher.

18. Haemostatic and resorbable compress according to claim 17 obtained from a viscose yarn textile.

19. Haemostatic and resorbable compress according to claim 17, having a primary alcohol oxidation selectivity of 70% or higher.

20. Method for preparing a compress according to claim 3, wherein the reaction medium is enriched with hypohalite when pH of the reaction medium reaches a value equal to 8.

21. Method for preparing a compress according to claim 5, wherein the oxoammonium salt comprises 2,2,6,6-tetramethylpiperidine-1-oxide (Tempo), present in an amount of 0.05 mole per mole of anhydro-glucose units in the cellulose (equivalent) in the reaction medium.

22. Method for preparing a compress according to claim 7, wherein the oxidation is carried out in the presence of a hypohalite regenerating salt, present in an amount of 0.5 mole per mole of anhydro-glucose units in the cellulose (equivalent) in the reaction medium.

23. Method for preparing, a compress according to claim 9, wherein the oxidation is stopped when the reaction medium reaches a pH plateau between 5 and 8, after 24 hours of reaction.

24. Method for preparing a compress according to claim 13, wherein, after oxidation, the compress is incubated in a protonation medium comprising hydrochloric acid (HCl).

25. Method for preparing a compress according to claim 24, wherein, after oxidation, the compress is incubated in a protonation medium comprising one or more baths of 1 mol/l (N) HCl for 1 to 10 hours.

26. Method for preparing a compress according to claim 14, wherein, after oxidation or after protonation, the compress is incubated in the presence of calcium acetate or CaCl₂.

27. Haemostatic and resorbable compress obtained by the method according to claim 17, at an oxidation rate of 12% or higher.

28. Haemostatic and resorbable compress according to claim 18, obtained from a viscose yarn textile having a hook mesh.

29. Haemostatic and resorbable compress according to claim 19, having a primary alcohol oxidation selectivity of 90% or higher.
